(19) United States
(12) Patent Application Publication
(10) Pub. No.: US 2004/0008255 A1
(43) Pub. Date: Jan. 15, 2004

(54) Vehicle video system and method

(76) Inventor: Mark A. Lewellen, Ozark, MO (US)

Correspondence Address: MARTIN & ASSOCIATES, LLC, P O BOX 548, CARTHAGE, MO, 64836-0548, US

(21) Appl. No.: 10/192,941

(22) Filed: Jul. 11, 2002

(51) Int. Cl. H04N 7/18

(52) U.S. Cl. 348/148

(57) ABSTRACT

A vehicle video system includes a small camera in the passenger area that uses illumination in the non-visible spectrum to illuminate the passenger area. The vehicle video system records video information on a digital video recorder that uses digital media such as a hard disk drive, recordable CD (CD-R), rewritable CD (CR-RW), or writable Digital Video Disc (DVD). The vehicle video system includes a local wireless interface, such as a Bluetooth-compatible interface, that automatically connects to a compatible device in the parking area of the vehicle that is coupled to a database. In this manner, the digital video information collected by the vehicle video system is automatically transferred to the database when the vehicle is parked, removing the need for any human intervention for the logging and cataloging of video tapes. The local wireless interface of the vehicle video system also allows other devices, such as a handheld device or a vehicle video system in a different vehicle, to access the stored digital video information.

### BACKGROUND OF THE INVENTION

1. Technical Field

This invention generally relates to video systems, and more particularly relates to video systems for vehicles such as police cars.

2. Background Art

Modern technological advances have changed the way that law enforcement personnel do their jobs. Many police cars now include portable computers or mobile data terminals that allow an officer to easily interact with a central computer system to check license plates, wants and warrants on an individual, etc. In addition, many patrol cars now include in-vehicle video systems.

One specific configuration for a known vehicle video system is disclosed in U.S. Pat. No. 5,677,979, issued to Squicciarini et al. on Oct. 14, 1997, entitled “Video Incident Capture System.” The block diagram of FIG. 1 shows many of the pertinent features of the system 100 disclosed in the Squicciarini patent. A system controller 102 is coupled to a front camera 110, a speed radar 120, a remote control unit 130, a wireless audio receiver 140, a VCR 170, and environmental controls 182. System controller 102 includes a real-time clock circuit 106 that generates a time and date 108. System controller 102 further includes an on-screen display circuit 104 that superimposes text information on the video signal received from the front camera 110. Thus, system controller 102 takes video input from the front camera 110 and input from the speed radar 120 regarding the speed of a monitored vehicle and the speed of the police cruiser, and outputs a video signal to VCR 170 that includes the front camera view along with text superimposed on the view that shows the vehicle speed, the police cruiser speed, and time and date. The video information stored to VCR 170 may also include audio information received via wireless audio receiver 140 from a wireless microphone 150 carried or worn by a police officer.

Front camera 110 is a camera that is mounted in the vehicle in a position to view the front view of the vehicle through the windshield. Speed radar 120 is a known speed radar commonly in use in law enforcement vehicles. Remote control unit 130 includes keys or buttons that allow an officer to remotely control the VCR 170 so that video can be played back from the video tape onto monitor 190.

VCR 170 is located within a vault that is in the trunk of the vehicle. Due to the sensitivity of VCRs and the tapes they record on, the vault is used not only to secure the VCR in a locked location within the trunk, but also to provide a climate-controlled environment. To this end, system controller 102 monitors the temperature within the vault 180, and activates the environmental controls 182 to heat or cool the vault, as necessary, to keep the interior of the vault (and hence, the VCR 170) within a desired range of operating temperature. The output of VCR 170 is routed to a monitor 190 that is positioned where an officer in the vehicle may review video information by activating controls on the remote control unit 130 to rewind and play a tape in the VCR 170.

The use of a VCR mounted in the vault of a police cruiser requires considerable effort on the part of officers or maintenance personnel to assure the system operates correctly. A prior art method 200 for using the system of FIG. 1 is shown in FIG. 2. At the beginning of a shift, when one or more police officers are ready to take a police cruiser on patrol, a new video tape must be loaded into the VCR in the vault in the trunk of the cruiser (step 210). The vehicle video system 100 then sends video information to the VCR for recording on the video tape (step 220). If the video tape becomes full before the shift is over (step 220=YES), the officer must stop the vehicle (step 230), get an empty video tape (step 232), access the VCR in the vault in the trunk of the cruiser (step 234), remove the full tape from the VCR (step 236), place the empty tape into the VCR (step 238), and store the full tape somewhere in the car (step 240). Even if the tape does not fill up during the shift (step 220=NO), at the end of the shift (step 250) the cruiser is parked at the station (step 260), the VCR in the vault in the trunk must be accessed (step 262), the video tape is removed from the VCR (step 264), and the tape, including any full tapes from the shift, are taken to long-term storage (step 266). These video tapes are typically indexed and cataloged for future reference. Needless to say, in a large police department with many cruisers, the managing and handling of a large number of video tapes becomes a time-consuming task that requires considerable space to store the video tapes.

While the prior art system described above provides a way for video information from a police cruiser to be collected and stored, it is not convenient, and there are many drawbacks, discussed above. Without a way for providing an improved system for generating and storing vehicle video information, the law enforcement community will continue to suffer from the inefficiencies of prior art systems.

### DISCLOSURE OF INVENTION

According to the preferred embodiments, a vehicle video system includes a small camera in the passenger area that uses illumination in the non-visible spectrum to illuminate the passenger area. The vehicle video system records video information on a digital video recorder that uses digital media such as a hard disk drive, recordable CD (CD-R), rewritable CD (CR-RW), or writable Digital Video Disc (DVD). The vehicle video system includes a local wireless interface, such as a Bluetooth-compatible interface, that automatically connects to a compatible device in the parking area of the vehicle that is coupled to a database. In this manner, the digital video information collected by the vehicle video system is automatically transferred to the database when the vehicle is parked, removing the need for any human intervention for the logging and cataloging of video tapes. The local wireless interface of the vehicle video system also allows other devices, such as a handheld device or a vehicle video system in a different vehicle, to access the stored digital video information.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a prior art vehicle video system;

FIG. 2 is a flow diagram of a prior art method for using the vehicle video system of FIG. 1;

FIG. 3 is a block diagram of a vehicle video system in accordance with the preferred embodiments;

FIG. 4 is a partial interior view of a vehicle door showing a sample mounting location for the passenger camera 360 shown in FIG. 3;

FIG. 5 is a block diagram showing how the vehicle video system 300 may communicate its stored digital video information to suitable compatible devices via its local wireless interface;

FIG. 6 is a flow diagram of a method for using the vehicle video system 300 of FIG. 3 in accordance with the preferred embodiments;

FIG. 7 is a flow diagram of a method in accordance with the preferred embodiments for the vehicle video system to communicate with compatible devices; and

FIG. 8 is a flow diagram of a method in accordance with the preferred embodiments for the vehicle video system to automatically transfer stored digital video information to a database when the vehicle is parked at its designated parking location.

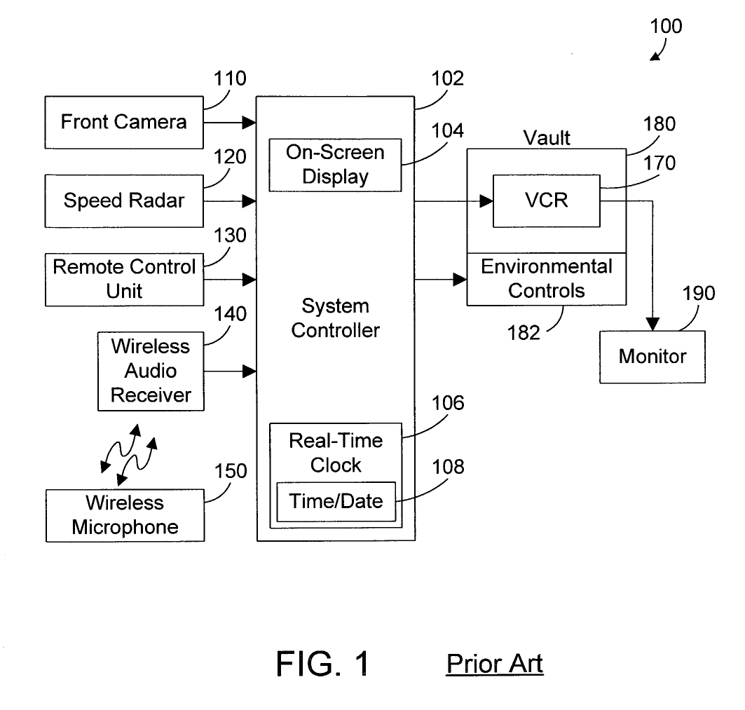

### BEST MODE FOR CARRYING OUT THE INVENTION

The vehicle video system and methods of the preferred embodiments allow storing a video image of a passenger area of the vehicle, allow storing the video information in a digital form, and allow automatically transferring the stored digital information to a database when the vehicle is parked at the conclusion of a shift.

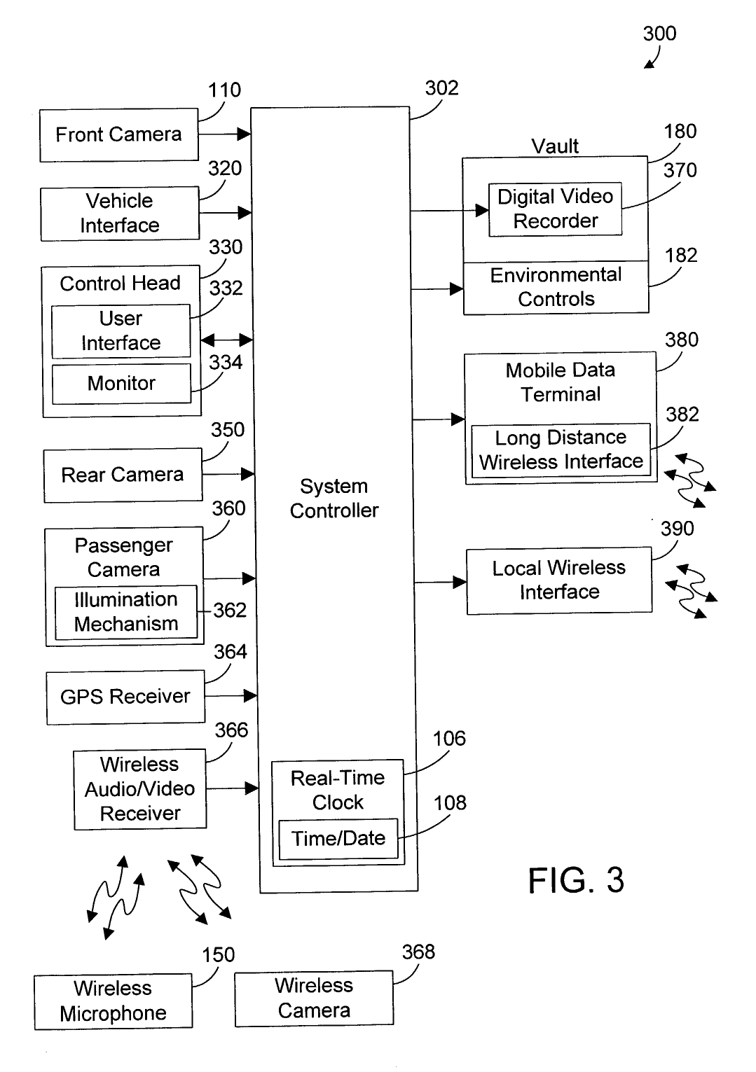

Referring to FIG. 3, a vehicle video system 300 in accordance with the preferred embodiments includes a system controller 302 that is coupled to: a front camera 110; a vehicle interface 320; a control head 330; a rear camera 350; a passenger camera 360; a global positioning system (GPS) receiver 364; a wireless audio/video receiver 366; a digital video recorder 370; environment controls 182; a mobile data terminal 380; and a local wireless interface 390. System controller 302 preferably includes a real-time clock circuit 106 that generates a time and date 108. In the alternative, system controller 302 could receive the time and date from an external real-time clock, or from any of the devices coupled to the system controller 302. Front camera 110 is a video camera that is mounted in the vehicle and positioned to view the front of the vehicle, preferably through the windshield. Vehicle interface 320 provides connections to different features of the vehicle, including the vehicle battery as a power supply, the light bar, the siren, the speedometer, etc. The vehicle interface allows automatically recording video information on the occurrence of specific events, such as when the light bar or siren is activated.

Control head 330 preferably includes a user interface 332 and a monitor 334. In the preferred embodiments, control head 330 is mounted between the visors of the vehicle, near the top of the windshield. This position allows easily viewing video information and controlling the function of the vehicle video system 300. The user interface 332 preferably includes buttons or keys the user may press, but may additionally or alternatively include other input devices, such as a voice recognition device. Monitor 334 is a small monitor that allows viewing the video information from the driver's seat.

Rear camera 350 is preferably similar to the front camera 110, and is fixedly mounted in the vehicle in a position that provides a rear view of the vehicle, preferably through the rear window. Passenger camera 360 is a small, inconspicuous camera mounted in the passenger area to monitor and record passenger activities. In the preferred embodiments, passenger camera 360 is preferably a monochromatic camera, such as a black and white camera. Passenger camera 360 includes an illumination mechanism 362 that provides illumination for the passenger area viewed by the passenger camera 360. In the preferred embodiment that uses a black and white camera, the illumination mechanism 362 includes one or more infrared (IR) light emitting diodes (LEDs). Black and white cameras are sensitive to infrared illumination that is invisible to the human eye. In this manner the passenger camera 360 can effectively illuminate the passenger area of a vehicle, even at night, without the passenger(s) knowing that the passenger camera 360 is present and operating. In a traditional patrol cruiser, the passenger camera 360 is placed in a position to view the back seat of the cruiser. In other police vehicles, such as vans, the passenger camera 360 may be mounted in any suitable location to view all or part of the passenger area.

The need for monitoring the activities of passengers in a law enforcement vehicle has become apparent over recent years due to charges of police brutality by arrested criminals. The issue of police brutality was brought to the forefront of public consciousness when a person videotaped the beating of Rodney King by police officers in the Los Angeles Police Department. Some criminals have attempted to play on this heightened awareness of police brutality by inflicting injuries to their own bodies while riding in the vehicle to supposedly support a claim of police brutality. Putting a passenger camera 360 in a position that monitors the passenger area of a vehicle is an effective way to record the activities of passengers. Thus, if an arrested criminal bangs his head on the car window, or on the metal partition between the front and back seats, to inflict an injury that he or she claims was inflicted by a law enforcement officer, the passenger camera will provide video proof that the injuries were self-inflicted, and not inflicted by any law enforcement officer.

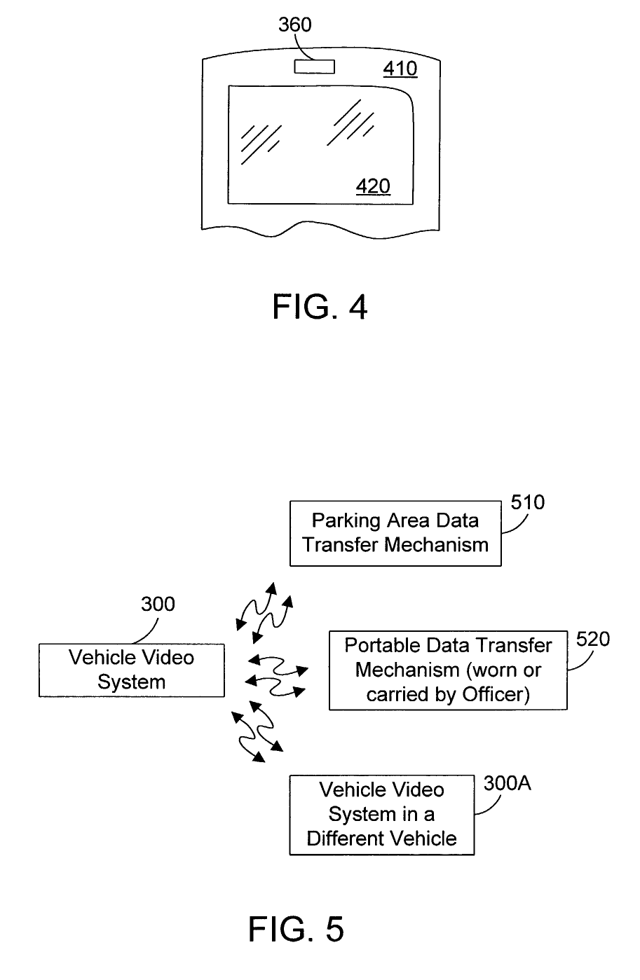

One suitable location for a passenger camera 360 of the preferred embodiments is in the back seat area of a police cruiser. Such a location is shown in FIG. 4, which shows a back door frame 410 with its window 420. Most police vehicles are special models of regular passenger cars. As such, they often include many of the features that most passenger cars have. For example, most police cruisers include a hook in the passenger compartment that allows hanging clothing on hangers from the hook, thereby allowing the transporting of clothing in a hanging position to prevent wrinkling. The passenger camera 360 of the preferred embodiments could be mounted at the location of the hook by removing the hook and placing the passenger camera 360 in its place, as shown in FIG. 4. In this manner the passenger camera 360 is placed in an inconspicuous location that can easily view the entire back seat of the police cruiser.

Referring back to FIG. 3, the vehicle video system 300 of the preferred embodiments includes a GPS receiver 364 that provides GPS coordinates to the system controller 302. The system controller 302 may incorporate the GPS data received from the GPS receiver 364 into the digital data stream that is output to the digital video recorder 370. In the alternative, the system controller 302 could use the GPS data in conjunction with stored digital map information to incorporate street names and direction into the digital data stream that is output to the digital video recorder 370. In other words, the system controller could indicate “Northbound on Broadway Ave” in the digital data stream based on the input from GPS receiver 364. Incorporating location information into the digital data stream provides location information that is not available in prior art vehicle video systems.

The wireless audio/video receiver 366 provides an audio and video interface to suitable wireless devices, such as a wireless microphone 150 and a wireless camera 368. These devices are preferably carried or worn by a law enforcement officer, allowing the officer to record both audio and video information from a location that is much closer to suspected criminals. By providing remote video information as well as audio, the vehicle video system 300 provides additional information that may be recorded by the digital video recorder 370.

Digital video recorder 370 is any suitable device for recording digital information, including a recordable compact disc (CR-R), a rewritable compact disc (CD-RW), a writable digital video disc (DVD), and a hard disk drive. Replacing bulky video tapes with smaller discs is an advantage over the prior art. However, the most advantageous implementation in accordance with the preferred embodiments uses a hard disk drive to record the digital video information. This digital video information may then be automatically uploaded to a database, as described in more detail below. Note that the label “digital video recorder” and “digital video information” does not imply that the recorder 370 is only capable of recording video information, but is intended in a broad sense to mean a recorder that can record any digital information, including digital video information. Digital video recorder 370 is preferably mounted in a vault 180, as in the prior art, that includes environmental controls 182. In the preferred embodiments, system controller 302 may monitor the temperature within the vault 180, and may then activate the necessary environmental controls 182, as required, to maintain the interior of the vault within a specified temperature range. In the alternative, the environmental controls 182 may function independently from the system controller 302 to maintain the interior of the vault within a specified temperature range.

Vehicle video system 300 preferably includes a mobile data terminal 380. Mobile data terminal 380 is a standard mobile data terminal known in the art and used by law enforcement officials. Mobile data terminal 380 typically includes a long distance wireless interface 382 that allows the mobile data terminal 380 to communicate directly with police headquarters. By providing a link between the mobile data terminal 380 and the system controller 302, audio and video information received by the mobile data terminal 380 could be presented on the control head 330. Thus, if an “all points bulletin” is issued for a suspected criminal and sent to the mobile data terminal 380 from police headquarters, the picture of the suspect could be displayed by system controller 302 on the monitor 334 of control head 330. Integrating the vehicle video system 300 with a mobile data terminal 380 allows these devices to share information. For example, any information recorded by digital video recorder 370 could be transmitted to police headquarters via the long distance wireless interface 382 in mobile data terminal 380.

Vehicle video system 300 includes a local wireless interface 390. Local wireless interface 390 provides a significant advantage over the prior art vehicle video systems. Local wireless interface 390 provides a means of communicating via short-range wireless communications. In the preferred embodiments, local wireless interface 390 is a Bluetooth-compatible interface, which can communicate with other Bluetooth-compatible devices over a typical range of 100 meters (330 feet).

Bluetooth wireless technology is a worldwide specification for a small-form factor, low-cost radio solution that provides links between mobile computers, mobile phones, other portable handheld devices, and connectivity to the Internet. The specification is developed, published and promoted by the Bluetooth Special Interest Group (SIG). The Bluetooth Special Interest Group (SIG) is a trade association comprised of leaders in the telecommunications, computing, and network industries, and is driving development of the technology and bringing it to market. The Bluetooth SIG promoters include IBM, 3Com, Agere, Ericsson, Intel, Microsoft, Motorola, Nokia and Toshiba, and hundreds of associate and adopter member companies.

Bluetooth wireless technology is unique in its breadth of applications. Links can be established between groups of products simultaneously or between individual products and the Internet. While point-to-point connections are supported, the specification allows up to seven simultaneous connections to be established and maintained by a single radio. This flexibility, combined with strict interoperability requirements, has led to support for Bluetooth wireless technology from a wide range of market segments, including software developers, silicon vendors, peripheral and camera manufacturers, mobile PC manufacturers and handheld device developers, consumer electronics manufacturers, car manufacturers, and test and measurement equipment manufacturers.

Hardware that complies with the Bluetooth wireless specification ensures communication compatibility worldwide. Bluetooth is generally designed to operate in a maximum range of one to one hundred meters, depending on the class of the device. Class 1 devices have a range up to 100 meters. Class 2 devices have a range up to ten meters. Class 3 devices have a range up to 1 meter. As a low-cost, low-power solution with industry-wide support, Bluetooth wireless technology allows effortlessly interconnecting with compatible devices all over the world.

Devices enabled with Bluetooth wireless technology will be able to: free electronic accessories and peripherals from wired connections; exchange files, business cards, and calendar appointments; transfer and synchronize data wirelessly; take advantage of localized content services in public areas; and function as remote controls, keys, tickets and e-cash wallets.

Many manufacturers of electronic devices are planning to integrate Bluetooth into their devices so their devices can automatically connect to other devices that have a Bluetooth interface within a short range. One goal of Bluetooth is to interconnect many electronic devices without using hard-wire cables. For example, a computer network that includes four computer systems, four monitors, a printer, and a scanner could theoretically be all interconnected via Bluetooth without using any cables to interconnect these items.

Bluetooth includes the capability of identifying each type of device as it establishes a link to other devices. Thus, a printer that has a Bluetooth interface will identify itself as a printer, which makes the print function available to other devices that are linked via Bluetooth to the printer. A mobile phone that includes a Bluetooth interface could automatically detect when it comes in range of a printer that has a Bluetooth interface, and in response to detecting the printer the mobile phone could provide an option to print e-mail or other text information received by the mobile phone, which would send the e-mail or other information to the printer. Details regarding Bluetooth and it's detailed specification may be found at www.bluetooth.com.

Unlike many other wireless standards, the Bluetooth wireless specification includes both link layer and application layer definitions for product developers. Radios that comply with the Bluetooth wireless specification operate in the unlicensed, 2.4 GHz radio spectrum ensuring communication compatibility worldwide. These radios use a spread spectrum, frequency hopping, full-duplex signal at up to 1600 hops/sec. The signal hops among 79 frequencies at 1 MHz intervals to give a high degree of interference immunity.

The 2.4 GHz band used by Bluetooth is unlicensed, and can be used by many other types of devices such as cordless phones, microwave ovens, and baby monitors. Any device designed for use in an unlicensed band should be designed for robustness in the presence of interference, and the Bluetooth wireless technology has many features that provide such robustness.

Products that incorporate a Bluetooth interface are already on the market. Nokia Corp. is selling its Bluetooth 6310 phones in Europe, and are expected to be available in the United States sometime in 2002. Broadcom Corp. and handheld PC maker Palm Inc. plan to co-develop a new Bluetooth handheld PC design.

There are other wireless standards that exist besides Bluetooth that could be used within the scope of the preferred embodiments. For example, Wi-Fi (IEEE 802.11b) is designed to provide wireless Ethernet connectivity that can extend or replace wired networks for dozens of computing devices. Wi-Fi is a trademark of WECA (the Wireless Ethernet Compatibility Alliance). The Bluetooth wireless technology is expected to be used widely as a cable replacement for devices such as PDAs, cell phones, cameras, speakers, headsets and so on. IEEE 802.11 will likely still be used for higher speed wireless Ethernet access, so it is widely expected that Bluetooth and 802.11 will co-exist. Preliminary tests by the Pennsylvania State University's Applied Research Laboratory show that Bluetooth and 802.11b (Wi-Fi) do not interfere with each other even in close proximity. IEEE 802.11(b)'s typical 284-foot range was unaffected by the presence of Bluetooth devices, while Bluetooth's typical 64-foot range was unaffected by the presence of 802.11(b) devices.

The main feature of local wireless interface 390 is that it is short-range. As such, it is not an interface that allows the vehicle video system 300 to communicate over long distances, such as with police headquarters. The long distance wireless interface 382 within mobile data terminal 380 allows the mobile data terminal 380 to directly communicate with police headquarters. This requires significant power and a receiver/transmitter that is relatively expensive. Local wireless interface 390, in contrast, is short range, low power, and very inexpensive. It is anticipated that Bluetooth-compatible interfaces will be available in chipsets that will sell in the $5 range in quantity. The local wireless interface 390 is thus a low-power, short range wireless interface that is very inexpensive.

The benefit of providing the local wireless interface 390 is that digital information recorded by the digital video recorder 370 may be automatically transmitted and received to and from compatible devices. As shown in FIG. 5, one example of a compatible device is a parking area data transfer mechanism 510. A second example of a compatible device is a portable data transfer mechanism 520. A third example of a compatible device is a vehicle video system 300A in a different vehicle.

Parking area data transfer mechanism 510 is preferably located in a parking area for the vehicle, such as in the parking garage at police headquarters where the cruisers are parked. We assume that a designated parking place for the vehicle puts the local wireless interface 390 of the vehicle video system in range of the parking area data transfer mechanism 510, which has a compatible local wireless interface. Once a link is established between the vehicle video system 300 and the parking area data transfer mechanism 510, digital information may be exchanged between the two. For example, the digital information recorded by the digital video recorder may be automatically uploaded to the parking area data transfer mechanism 510 for storage in a database. In addition, the parking area data transfer mechanism 510 may download digital information to the vehicle video system 300 via local wireless interface 390.

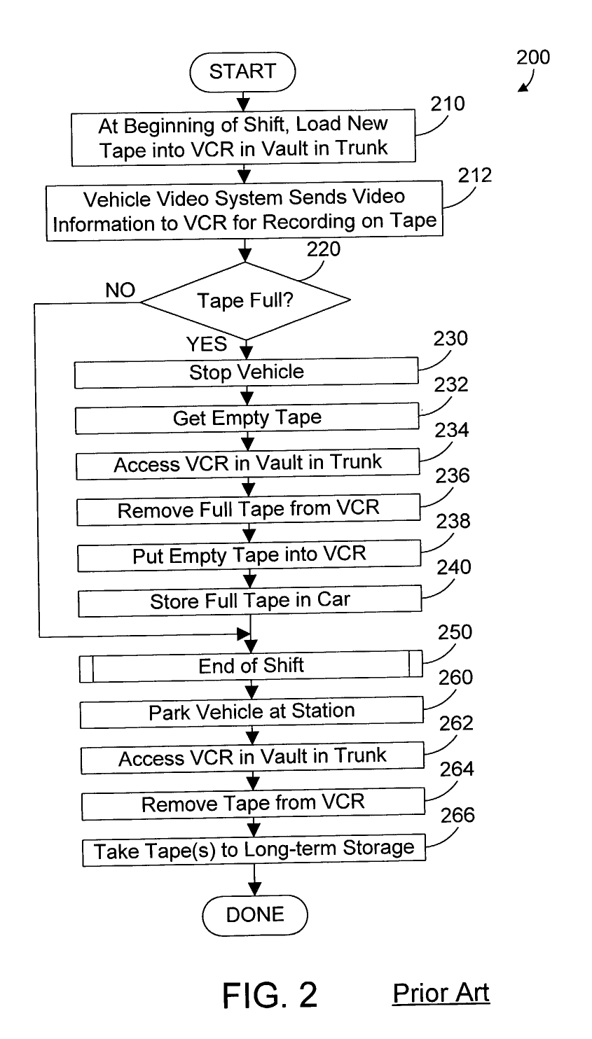

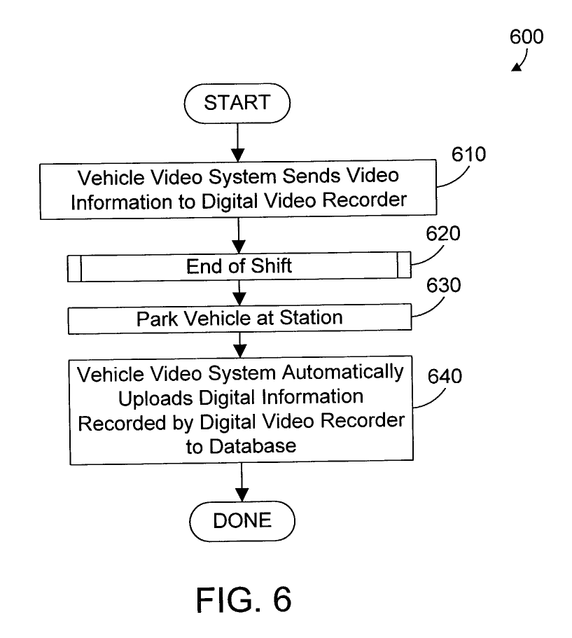

The presence of local wireless interface 390 within vehicle video system 300 and the presence of parking area data transfer mechanism 510 allows the operation of the vehicle video system 300 to be much simpler than the prior art method shown in FIG. 2. Referring to FIG. 6, a method 600 in accordance with the preferred embodiments is shown. The vehicle video system sends video information and possibly other digital information to the digital video recorder (step 610). At the end of the shift (step 620) we assume that the vehicle is parked in its designated spot at the station (step 630). The vehicle video system then communicates with the parking area data transfer mechanism, and uploads its digital information to a database coupled to the parking area data transfer mechanism (step 640). As seen by comparing prior art method 200 of FIG. 2 and method 600 of FIG. 6 in accordance with the preferred embodiments, the present invention relieves the law enforcement officer from the chore of handling video tapes and relieves the police station from the hassle, space, and expense of cataloging and storing video tapes.

Referring back to FIG. 5, a second suitable wireless device that is compatible with the local wireless interface 390 in the vehicle video system 300 is a portable data transfer mechanism 520, which may be worn or carried by a law enforcement officer. Such a portable data transfer mechanism 520 could act in the same manner as the parking area data transfer mechanism 510, exchanging digital information in both directions as needed. Note, however, that the portable nature of the portable data transfer mechanism 520 allows for easily exchanging digital information with the vehicle video system 300 in the field, without having to return to the parking garage.

A third suitable wireless device that is compatible with the local wireless interface 390 in the vehicle video system 300 is a vehicle video system 300A in a different vehicle. In this manner, two vehicle video systems 300 and 300A may exchange digital information with each other in the field. But why would digital information exchange in the field be useful if a parking area data transfer mechanism 510 is present? An example will illustrate. Let's assume that a police car is in high-speed pursuit of a suspected criminal. During the chase, let's assume that the police car is wrecked. If the only data transfer mechanism were in the parking garage, the car would have to be towed to the parking garage to retrieve the digital information recorded by the digital video recorder 370. However, with a portable data transfer mechanism 520 or using a vehicle video system in a different vehicle 300A, the stored digital information in the wrecked police car can be uploaded to a different device, which can then transfer the data to the central database. We see from this simple example that exchange of digital information in the field is a significant advantage of the preferred embodiments.

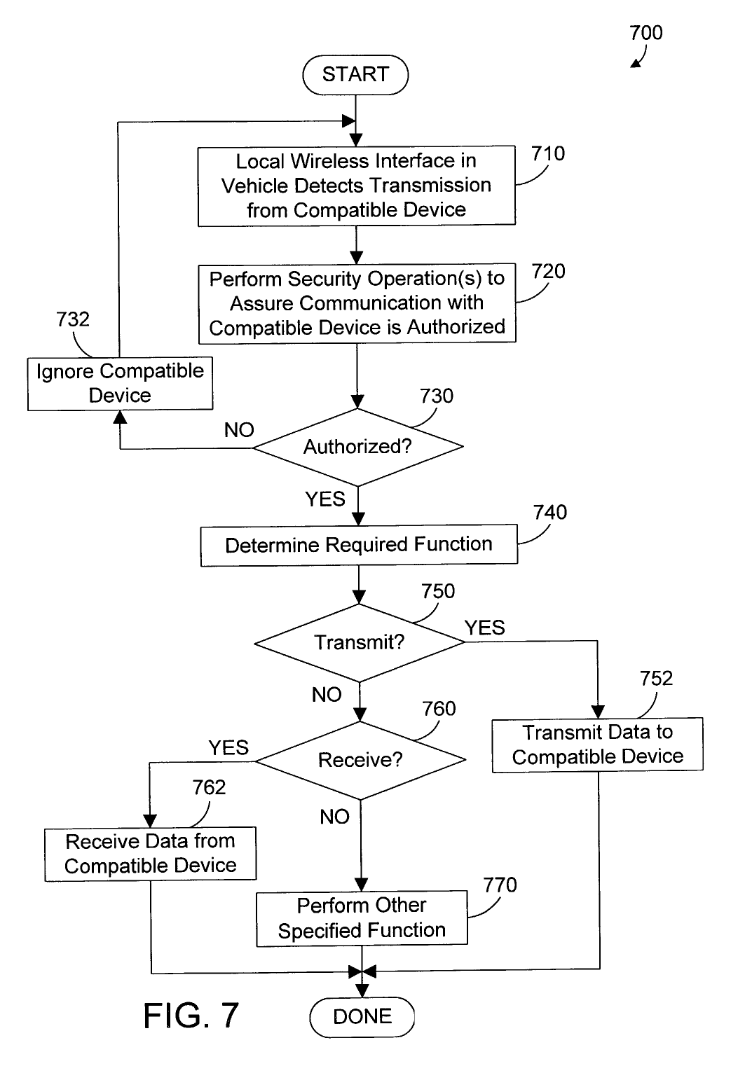

The presence of local wireless interface 390 in vehicle video system 300 presents the possibility that unauthorized parties may attempt to access information stored by the vehicle video system 300. A method is thus needed that assures that the vehicle video system exchanges data only with authorized devices. One such method is shown by way of example in FIG. 7. Method 700 begins when a local wireless interface in a vehicle video system detects a transmission from a compatible device (step 710). Once the link between the two systems is established, method 700 performs one or more security operations to assure that communication with the compatible device is authorized (step 720). The number and type of security operations may vary widely within the scope of the preferred embodiments, and are intended to assure that only authorized devices may exchange information with the vehicle video system 300. If the security operations indicate that the compatible device is not authorized (step 730=NO), no response is made to the compatible device, effectively ignoring it (step 732). If the compatible device is authorized to access the vehicle video system (step 730=YES), the vehicle video system then determines from one or more messages received from the authorized device what function is required (step 740). If the function is that the vehicle video system should transmit digital information to the compatible device (step 750=YES), the digital information is transmitted (step 752). If the function is that the vehicle video system should receive digital information from the compatible device (step 760=YES), the vehicle video system receives data from the compatible device (step 762). If the required function is neither transmit nor receive, the other specified function may be performed by the vehicle video system (step 770). One suitable example of “other specified function” in step 770 is a message from the compatible device that tells the vehicle video system to perform certain diagnostic tests. Of course, many other types of specified functions may also be performed, and step 770 expressly includes any function by the vehicle video system other than transmission (step 752) and reception (step 762) of digital information.

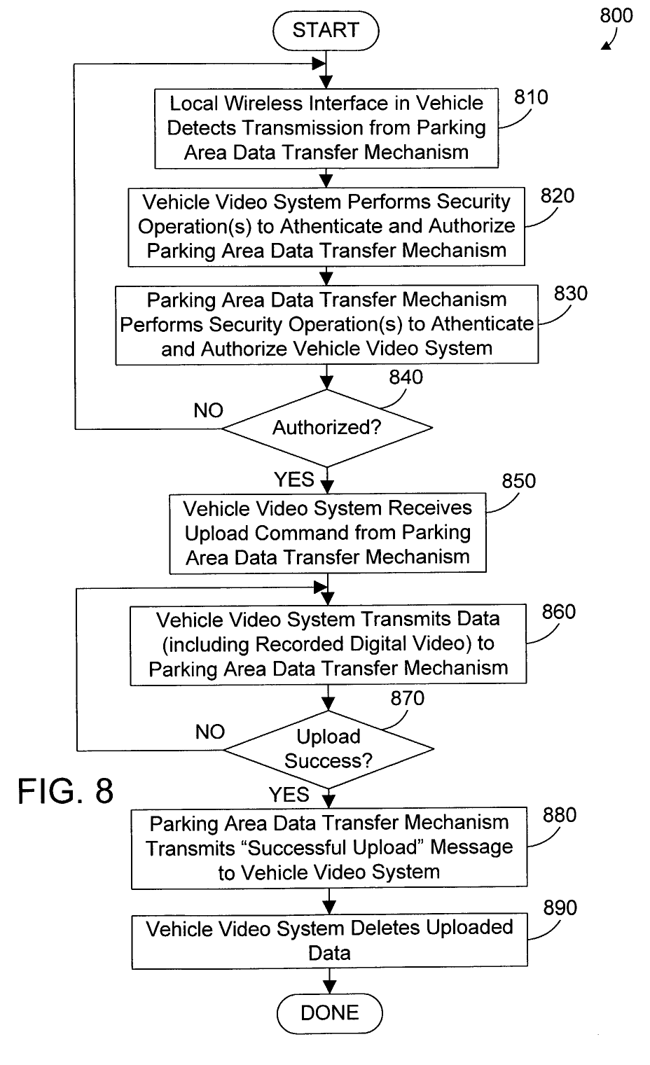

One specific detailed method 800 in FIG. 8 is shown as a specific implementation of a method within the scope of method 700 shown in FIG. 7. Method 800 is a detailed method that could be used to automatically upload digital information from the vehicle video system to a database via a parking area data transfer mechanism (such as 510 in FIG. 5). First, the local wireless interface in the vehicle video system detects a transmission from the parking area data transfer mechanism (step 810). The vehicle video system performs one or more security operations to authenticate and authorize the parking area data transfer mechanism, to assure that it is authorized to access the vehicle video system (step 820). The parking area data transfer mechanism also performs one or more security operations to assure that the vehicle video system is authorized to communicate with the parking area data transfer mechanism (step 830). If both are authorized to access the other (step 840=YES), the vehicle video system receives an “upload” command from the parking area data transfer mechanism (step 850). This upload command may be defined in any suitable manner, so long as the vehicle video system can recognize it. In response to the upload command, the vehicle video system transmits digital data to the parking area data transfer mechanism (step 860). This data includes the recorded digital video data. If the upload is not successful (step 870=NO), the transmission step is repeated until the upload is successful (step 870=YES). Upon successful upload of the stored digital information, the parking area data transfer mechanism transmits a “successful upload” message to the vehicle video system (step 880). In response, the vehicle video system may delete the uploaded data (step 890), creating space for storage of more digital information in the future. Note that the deletion of uploaded data in step 890 is optional. Rather than deleting the uploaded data, the vehicle video system could archive the uploaded data, retaining the data in a compressed format. Depending on the amount of video information that can be stored in the vehicle video system, it may be that no information is deleted until the media used to store the information (e.g., a hard disk drive) is a certain percentage full. The cost of hard drive space has become so inexpensive in recent years that it is possible to store several days worth of digital video information on a single hard disk drive. In such a system, a first-in last-out scheme could be used to delete the oldest information when space is needed for new information. Of course, many variations are also possible within the scope of the preferred embodiments, which expressly extend to any scheme for maintaining or deleting information stored by the digital video recorder in the vehicle video system.

The vehicle video system and method in accordance with the preferred embodiments can provide a significant advantage. First, the vehicle video system provides an inconspicuous camera in the passenger area of the vehicle to monitor and record activity in the passenger area. In addition, it stores the information in a digital form that may be stored on a recordable compact disc (CD-R), a rewritable compact disc (CR-RW), or writable digital video disc (DVD). Because these types of discs are much smaller than a video tape, the requirements for storage space for these discs are considerably reduced. In addition, the digital video information need not be written to a permanent media in the vehicle, but could instead be recorded on a hard disk drive, then uploaded to a database when the vehicle is parked at the end of a shift. This reduces all storage and management of physical media, because the video information can be stored in the database directly. By removing much of the overhead in handling physical media, the preferred embodiments greatly simplify the life of law enforcement personnel, allowing them to concentrate more on their jobs of enforcing the laws rather than spending time fussing with the technological tools that assist them.

While the invention has been particularly shown and described with reference to preferred embodiments thereof, it will be understood by those skilled in the art that various changes in form and details may be made therein without departing from the spirit and scope of the invention.

I claim:

1. A video system for a vehicle comprising:
a first camera fixedly mounted to the vehicle in a position that allows the first camera to view a front view of the vehicle through the windshield;
a second camera fixedly mounted to the vehicle in a position that allows the second camera to view a passenger area of the vehicle, the second camera comprising a monochromatic camera that includes at least one illumination mechanism that provides illumination that is not visible to a human eye but that provides illumination for the monochromatic camera;
a digital video recorder; and
a system controller coupled to the first camera, to the second camera, and to the digital video recorder, the system controller sending a digital data stream that includes video information from the first camera and from the second camera to the digital video recorder.

2. The video system of claim 1 further comprising:
a control head coupled to the system controller, the control head comprising:
a user interface that allows a user to control the function of the system controller; and
a monitor that displays video information from at least one of the first camera, the second camera, and the digital video recorder.

3. The video system of claim 1 further comprising:
a global positioning system (GPS) receiver coupled to the system controller that provides location coordinates for the vehicle to the system controller.

4. The video system of claim 1 further comprising:
a wireless audio and video receiver coupled to the system controller that allows at least one wireless microphone and at least one wireless camera to send information to the system controller.

5. The video system of claim 1 further comprising:
a mobile data terminal coupled to the system controller, the mobile data terminal being coupled via a wireless communication mechanism to a central database.

6. A video system for a vehicle comprising:
at least one camera mounted in the vehicle;
a digital video recorder mounted in the vehicle; and
a system controller coupled to the at least one camera and to the digital video recorder, the system controller sending a digital data stream that includes video information from the at least one camera to the digital video recorder.

7. A video system for a vehicle comprising:
at least one camera mounted in the vehicle;
a digital video recorder mounted in the vehicle;
a local wireless interface for directly communicating with at least one compatible local wireless device within a specified range of the vehicle; and
a system controller coupled to the at least one camera, to the digital video recorder, and to the local wireless interface, the system controller sending a digital data stream that includes video information from the at least one camera to the digital video recorder, the system controller communicating with the at least one compatible local wireless device only after performing at least one security function to assure the compatible local wireless device is authorized to communicate with the video system.

8. The video system of claim 7 further comprising a parking area data transfer mechanism in a parking area for the vehicle that is a compatible wireless device and that receives via the local wireless interface digital video information stored by the digital video recorder.

9. The video system of claim 7 further comprising a portable data transfer mechanism that is a compatible wireless device and that receives via the local wireless interface digital video information stored by the digital video recorder.

10. The video system of claim 7 wherein the local wireless interface comprises a Bluetooth-compatible interface.

11. The video system of claim 7 further comprising:
a control head coupled to the system controller, the control head comprising:
a user interface that allows a user to control the function of the system controller; and
a monitor that displays video information from at least one of the at least one camera and the digital video recorder.

12. The video system of claim 7 further comprising:
a global positioning system (GPS) receiver coupled to the system controller that provides location coordinates for the vehicle to the system controller.

13. The video system of claim 7 further comprising:
a wireless audio and video receiver coupled to the system controller that allows at least one wireless microphone and at least one wireless camera to send information to the system controller.

14. The video system of claim 7 further comprising:
a mobile data terminal coupled to the system controller, the mobile data terminal being coupled via a wireless communication mechanism to a central database.

15. A video system for a vehicle comprising:
(A) a first camera fixedly mounted to the vehicle in a position that allows the first camera to view a front view of the vehicle through the windshield;
(B) a second camera fixedly mounted to the vehicle in a position that allows the second camera to view a passenger area of the vehicle, the second camera comprising a monochromatic camera that includes at least one illumination mechanism that provides illumination that is not visible to a human eye but that provides illumination for the monochromatic camera;
(C) a local wireless interface for directly communicating with at least one compatible local wireless device within a specified range of the vehicle;
(D) a digital video recorder;
(E) a system controller coupled to the first camera, to the second camera, and to the digital video recorder, the system controller sending a digital data stream that includes video information from the first camera and from the second camera to the digital video recorder;
(F) a control head coupled to the system controller, the control head comprising:
a user interface that allows a user to control the function of the system controller; and
a monitor that displays video information from at least one of the first camera, the second camera, and the digital video recorder;
(G) a global positioning system (GPS) receiver coupled to the system controller that provides location coordinates for the vehicle to the system controller;
(H) a wireless audio and video receiver coupled to the system controller that allows at least one wireless microphone and at least one wireless camera to send information to the system controller;
(I) a mobile data terminal coupled to the system controller, the mobile data terminal being coupled via a wireless communication mechanism to a central database.

16. The video system of claim 15 further comprising a parking area data transfer mechanism in a parking area for the vehicle that is a compatible wireless device and that receives via the local wireless interface digital video information stored by the digital video recorder.

17. The video system of claim 15 further comprising a portable data transfer mechanism that is a compatible wireless device and that receives via the local wireless interface digital video information stored by the digital video recorder.

18. The video system of claim 15 wherein the local wireless interface comprises a Bluetooth-compatible interface.

19. A method for recording information relating to a vehicle, the method comprising the steps of:
mounting a monochromatic camera in a position in the vehicle that allows the camera to view a passenger area of the vehicle, the camera including at least one illumination mechanism that provides illumination that is not visible to a human eye but that provides illumination for the monochromatic camera;
activating the illumination mechanism; and
recording a video image from the monochromatic camera.

20. A method for digitally recording information relating to a vehicle, the method comprising the steps of:
mounting at least one camera in the vehicle;
providing a digital video recorder in the vehicle; and
sending a digital data stream that includes video information from the at least one camera to the digital video recorder.

21. A method for digitally recording information relating to a vehicle, the method comprising the steps of:
(A) providing a vehicle video system comprising:
at least one camera mounted in the vehicle;
a digital video recorder mounted in the vehicle;
a local wireless interface for directly communicating with at least one compatible local wireless device within a specified range of the vehicle; and
a system controller coupled to the at least one camera, to the digital video recorder, and to the local wireless interface;
(B) sending a digital data stream that includes video information from the at least one camera to the digital video recorder; and
(C) communicating with the at least one compatible local wireless device only after performing at least one security function to assure the compatible local wireless device is authorized to communicate with the vehicle video system.

22. A method for automatically transferring digital information in a vehicle video system, the method comprising the steps of:
communicating via a local wireless interface with a compatible device;
performing at least one security operation to verify that the compatible device is authorized to access the vehicle video system;
if the compatible device is authorized to access the vehicle video system, sending the digital information to the compatible device.

23. The method of claim 22 wherein the local wireless interface comprises a Bluetooth-compatible interface.

24. A method for automatically transferring digital information in a vehicle video system to a database, the method comprising the steps of:
the vehicle video system communicating via a local wireless interface with a data transfer mechanism;
the vehicle video system performing at least one security operation to verify that the data transfer mechanism is authorized to access the vehicle video system;
the data transfer mechanism performing at least one security operation to verify that the vehicle video system is authorized to access the data transfer mechanism;
if the data transfer mechanism is authorized to access the vehicle video system and the vehicle video system is authorized to access the data transfer mechanism, performing the steps of:
the vehicle video system sending the digital information to the data transfer mechanism;
the data transfer mechanism storing the digital information in the database.

25. The method of claim 24 wherein the local wireless interface comprises a Bluetooth-compatible interface.

26. The method of claim 24 further comprising the steps of:
the data transfer mechanism sending a message to the vehicle video system when the digital information has been successfully received from the vehicle video system; and
the vehicle video system performing at least one operation on the digital information sent to the data transfer mechanism.

27. The method of claim 26 wherein the at least one operation includes archiving the digital information.

28. The method of claim 26 wherein the at least one operation includes compressing the digital information.

29. The method of claim 26 wherein the at least one operation includes deleting the digital information.
